(19) United States
(12) Patent Application Publication
(10) Pub. No.: US 2002/0119807 A1
(43) Pub. Date: Aug. 29, 2002

(54) Mobile phone with electronic voice date book

(76) Inventors: Hsi-Che Lee, Taipei (TW); Tung-Hsing Pan, Taipei (TW); Mei-Jiuan Chan, Taipei (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/790,876

(22) Filed: Feb. 23, 2001

(51) Int. Cl. H04B 1/38

(52) U.S. Cl. 455/567; 455/566; 455/563

(57) ABSTRACT

A mobile phone with an electronic voice date book includes a receiver, a transmitter, a RF/IF (radio frequency/Intermediate Frequency), a baseline processor, a personal information manager, a keypad, a LCD (liquid crystal display) screen, a voice IC, a microphone, a speaker, a memory, two drivers, a vibrator and an electric bell. To record an event, users assign an alarm through the keypad and leave a voice message through the microphone. The voice message is stored in the voice IC, and the alarm setting is saved to the memory. The drivers activate the vibrator or the electric bell according to the time preset in the memory, and the speaker simultaneously plays the message to remind users of the event.

### BACKGROUND OF THE INVENTION

I. Field of the Invention

This invention relates generally to a mobile phone with an electronic voice date book and, more specifically, to a mobile phone with an electronic voice date book that saves voice messages in a voice IC and alarm settings in the memory. According to the alarm setting in the memory, the drivers activate a vibrator or an electric bell, and a speaker plays the recorded message to remind the mobile phone users of the event.

II. Description of the Prior Art

As mobile telecommunication technology rapidly develops, mobile phones offer a high performance that ensures users to stay in touch wherever they are, especially at moments of emergency. With rapidly increasing number of mobile phone users, however, the function of mobile phone does not go beyond that of a conventional telephone.

Heretofore, it is known to construct a date book in terms of a calendar printed on paper, on which users have to write down messages for events. With a date book of such construction, users have to constantly check on the written messages for upcoming events. Nonetheless, users might easily forget or have no time to check the calendar as they are occupied with numerous assignments at work, which is likely to lead to unpredicted loss.

It is also known to maintain a date book with the assistance of a secretary. The typical duty of a secretary is to record and arrange meetings for users. However, the salary of a secretary is not affordable for everyone, and secretaries may also forget or have no time to check the calendar for users.

The present invention improves on the heretofore known date book maintenance by providing a mobile phone with an electronic voice date book as an add-on function. The electronic voice date book is composed of a receiver, a transmitter, a RF/IF( Radio Frequency/Intermediate Frequency), a baseline processor, a personal information manager, a keypad, a LCD (liquid crystal display) screen, a voice IC, a microphone, a speaker, a memory, two drivers, a vibrator and an electric bell. Users are to record a given event by leaving a voice message through the microphone and assigning an alarm through the keypad. The voice message is stored in the voice IC, and the alarm setting is saved in the memory. According to the alarm setting preset in the memory, the drivers activate a vibrator or an electric bell, and a speaker plays the recorded message simultaneously to remind users of the given event.

### SUMMARY OF THE INVENTION

It is therefore a primary object of the invention to provide mobile phone with an electronic voice date book, which users can record voice messages for daily events in a voice IC and assign alarms to be saved in the memory. The drivers would activate a vibrator or an electronic bell according to the preset alarm, when the speaker simultaneously plays the recorded message in order to remind users of the event.

### BRIEF DESCRIPTION OF THE DRAWINGS

An embodiment of the invention will now be described by way of example only, with reference to the accompanying drawing, in which:

FIG. 1 is a circuit connection plan of an embodiment of the present invention;

FIG. 2 is a circuit connection plan of another embodiment of the present invention;

FIG. 3 is a circuit connection plan of a further embodiment of the present invention;

FIG. 4 is a flowchart illustrating the procedure for program setting (I);

FIG. 5 is another flowchart illustrating the procedure for program setting (II);

FIG. 6 is a flowchart illustrating the procedure for searching and deleting a given event;

FIG. 7 is a flowchart for the operation of the main program.

### DESCRIPTION OF THE PREFERRED EMBODIMENT

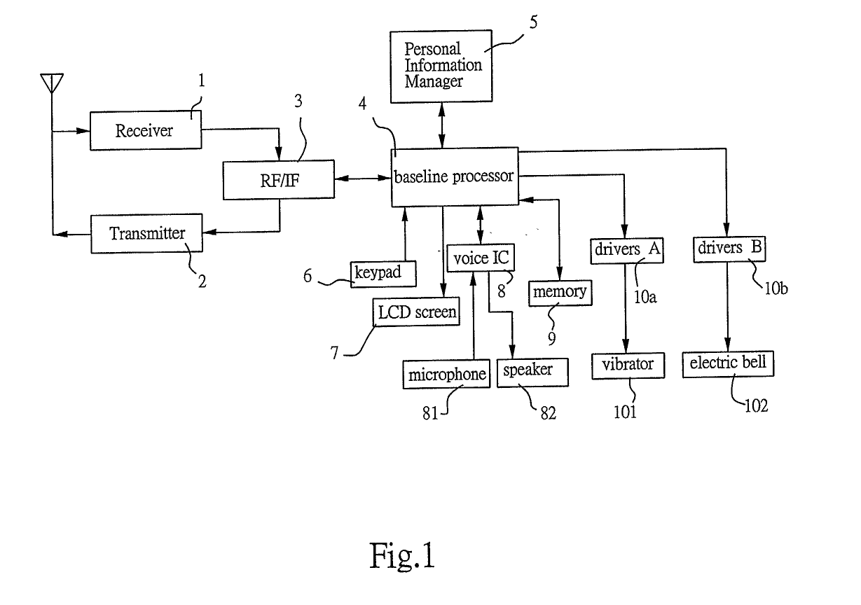

Referring to FIG. 1, the present invention is composed of a receiver 1, a transmitter 2, a RF/IF 3, a baseline processor 4, a personal information manager 5, a keypad 6, a LCD screen 7, a voice IC 8, a microphone 81, a speaker 82, a memory 9, two drivers 10a, 10b, a vibrator 101 and an electric bell 102. The functions of each component are described below:

The receiver 1 receives wireless signals, and the transmitter 2 sends out wireless signals. The RF/IF 3, connected to the receiver 1 and the transmitter 2, converts the high-frequency signals from the receiver 1 to middle-frequency ones and/or converts the middle-frequency signals to high-frequency ones for the transmitter 2 to send out.

The baseline processor 4, linked to the RF/IF 3, controls the inner circuit of the present invention. The personal information manager 5, connected to the baseline processor 4, is used for storing and executing application programs, as well as controlling the various application programs for the inner circuit along with the baseline processor 4.

The keypad 6,connected with the baseline processor 4, is used for entering setting and commands. The LCD screen 7 is also linked to the baseline processor 4, displaying digital information stored in the date book or entered by users. The voice IC 8 is connected to the baseline processor 4 as well as to a microphone 81 and a speaker 82. Voice messages are to be recorded through the microphone 81, stored in the voice IC 8, and played through the speaker 82.

The memory 9, connected to the baseline processor 4, stores the time setting input from the key pad 6. Two drivers 10a, 10b are connected to the baseline processor 4, with the driver 10a connecting a vibrator 101 and the driver 10b connecting to an electric bell 102. These drivers 1Oa, 10b would activate the vibrator 101 and the electric bell 102 at the preset time to remind users of a specific event.

Users can enter commands of setting, deleting and resetting through the keypad 6, during which the LCD screen 7 displays the information about time settings for users to easily operate on the keypad 6 to assign an alarm.

Further, users can record a voice message by speaking through the microphone 81. The voice message will be converted to digital signals and then stored in the voice IC 8.

Once users complete a setting, the personal information manager 5 monitors the time setting saved in the memory 9 and sends out signals to the drivers 10a, 10b and the voice IC 8 at the preset time. In turn, the drivers 10a, 10b would activate the vibrator 101 and/or the electric bell 102, and the speaker 82 would play the voice messages previously recorded in the voice IC 8 to remind users of the event.

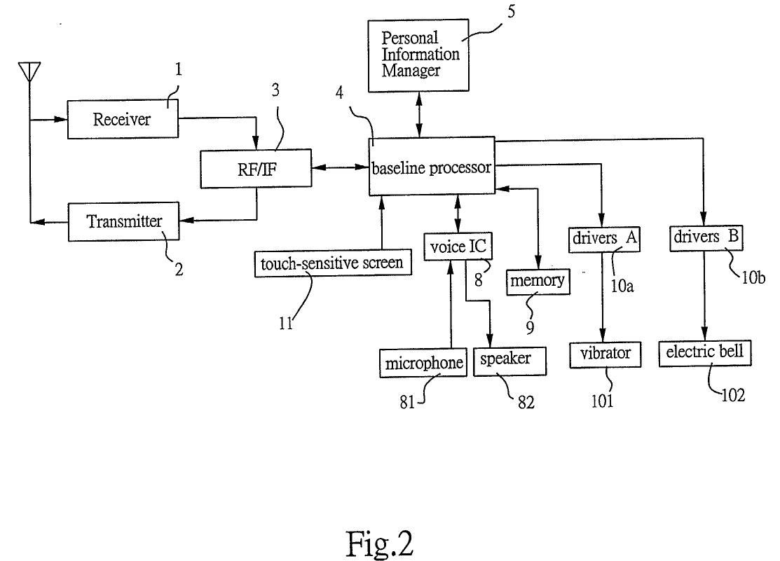

Referring to FIG. 2 that demonstrates an application of the present invention, the functions of the keypad 6 and the LCD screen 7 can be combined by applying a touch-sensitive screen 11, which is typically used for PDAs. Users can enter commands by tapping or clicking elements on the screen, which then displays the commands as well as other information of the date book.

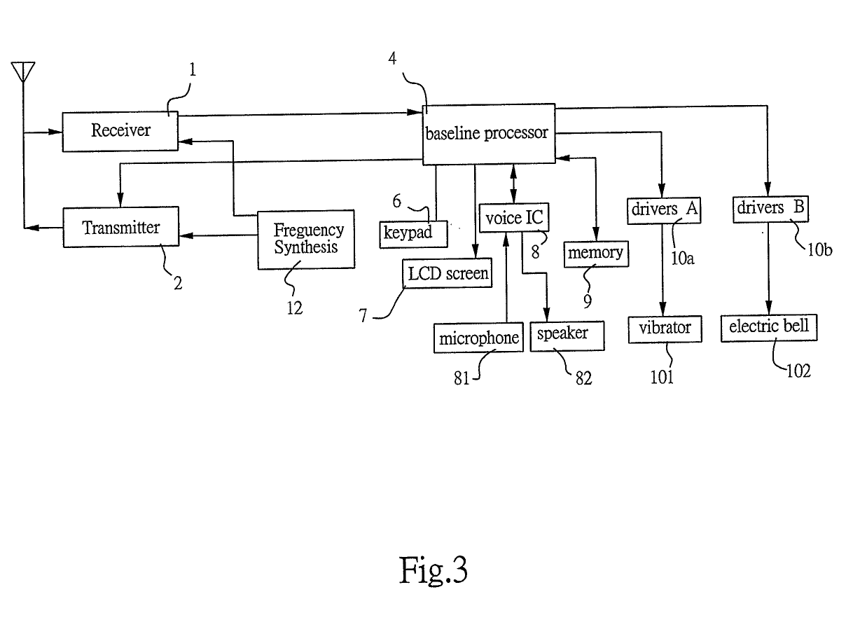

The construction of the invention described so far is based on a GSM ( Global System for Mobile Communication ) system. Refer to FIG. 3 for a construction of a CDMA(Code Division Multiple Access) & TDMA (Time Division Multiple Access) system, where the receiver 1 and the transmitter 2 are connected not only to the baseline processor 4 but also to a frequency synthesizer 12. The frequency synthesizer 12 generates high-frequency signals, which are required for mobile phones of a CDMA & TDMA system.

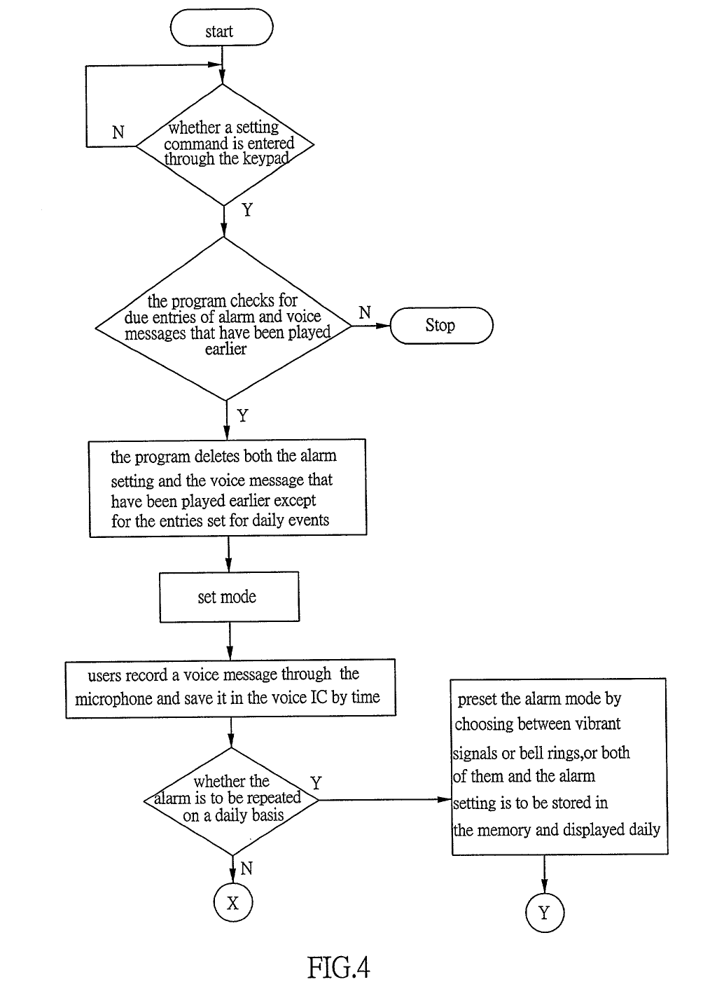

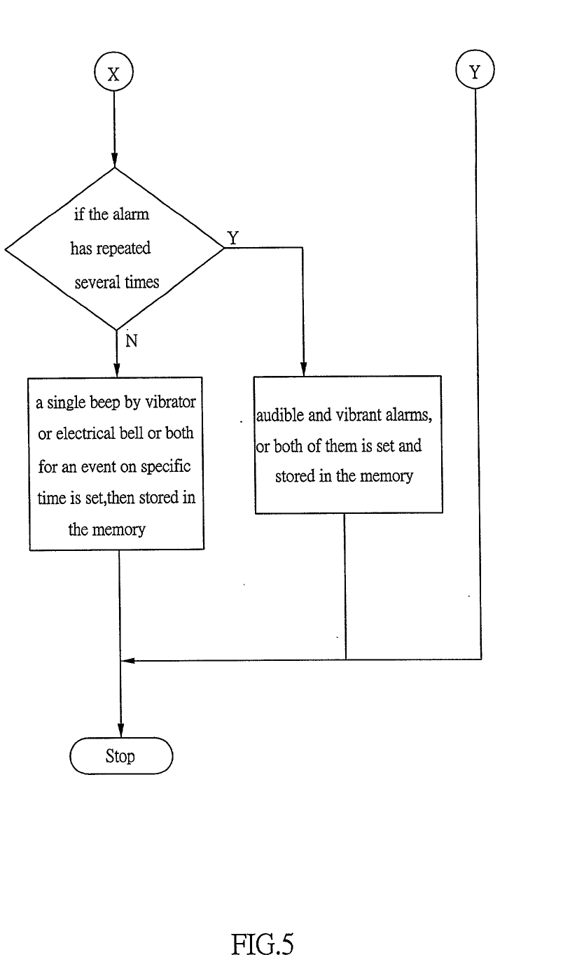

The procedure for setting up a schedule can be seen in FIG. 4 and FIG. 5. The program first detects whether a setting command is entered through the keypad 6. If yes, the program checks for overdue entries of alarm and voice messages that have been played earlier. If there is none, the program stops. If there is any overdue entry of alarm and voice message, users can delete both the alarm setting and the voice message that have been played while keeping the entries for daily events.

The program precedes to the presetting mode, in which users record a voice message for an event through the microphone 81 and save it in the voice IC 8 by time. Users then assign an alarm for the event by indicating whether the alarm is to be repeated on a daily basis and at the same time choosing between audible (bell ringing) 102 and vibrant (soundless) 101 alarms, or both of them. The alarm setting is to be stored in the memory 9. Users have to decide how frequently the alarm is to trigger and how the alarm is to trigger (i.e., activating a vibrant 101 or an electric bell 102). The alarm setting is to be stored in the memory 9.

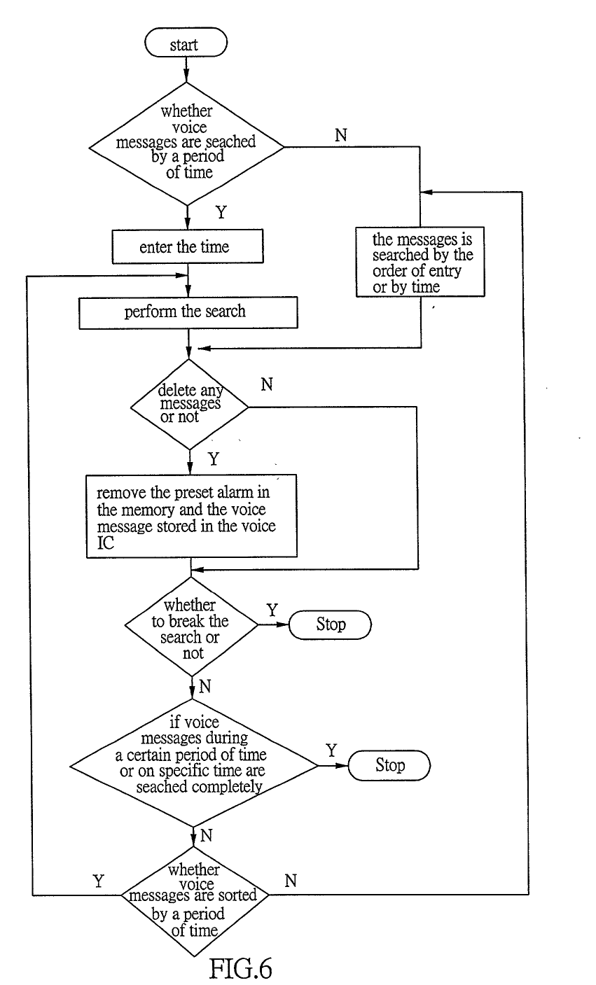

As the presetting completes, users can perform commands of searching and deleting, as shown in FIG. 6. If users prefer to check for an event scheduled at a specific time, they enter the time and perform the search. If users do not enter a specific time, they would view the messages by the order of entry or time. Users can choose to delete any entry, removing the preset alarm in the memory 9 and the voice message stored in the voice IC 8. The search and deletion procedure can be performed repeatedly to remove or revise all the entries in the date book. When users finish searching and deleting, they can escape from the search and deletion mode. Or they can break the search before searching completely.

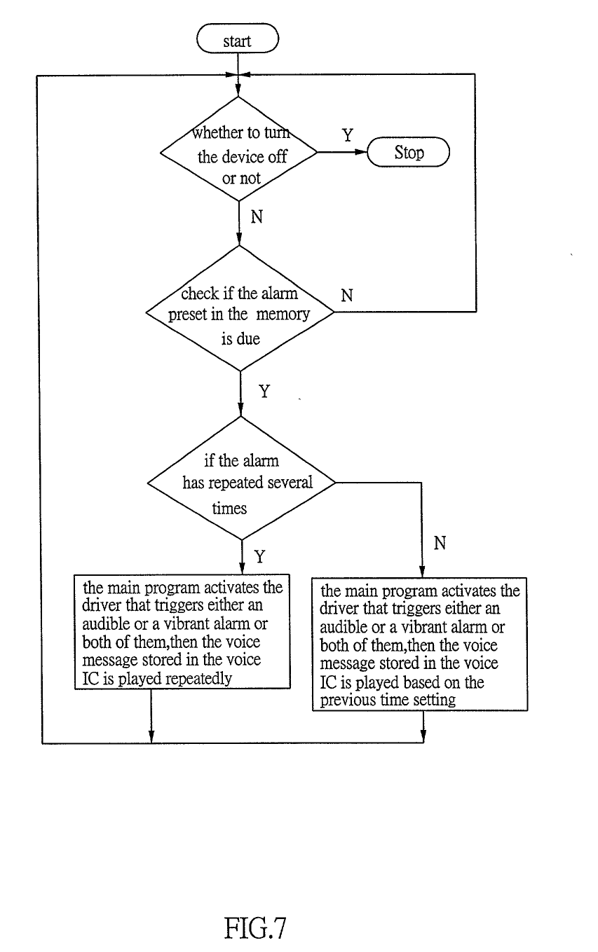

Referring to FIG. 7, once the presetting is completed, the date book enters the main program. If receiving a turn-off command, the main program turns off the device; otherwise, the main program monitors the alarm presets stored in the memory 9. Based on the alarm setting, the main program determines when and how frequently the drivers are to activate the alarm (i.e., the vibrator 101 or the electric bell 102) and the speaker is to play the voice message stored in the voice IC 8 at specific time or repeatedly.

While a preferred embodiment of the invention has been shown and described in detail, it will be readily understood and appreciated that numerous omissions, changes and additions may be made without departing from the spirit and scope of the invention.

What is claimed is:

1. An mobile phone with electronic voice date book comprising:
a receiver receiving wireless signals;
a transmitter sending out wireless signals;
a RF/IF, connected to said receiver and said transmitter, converting high-frequency signals from said receiver to middle-frequency ones and converting middle frequency signals to high-frequency ones for said transmitter to send out;
a baseline processor, connected to said RF/IF, controlling the inner circuit;
a personal information manager, connected to said baseline processor, storing and executing application programs and working with said baseline processor to control application programs for the inner circuit;
a keypad, connected to said baseline processor, used for entering settings and commands;
a LCD screen, connected to said baseline processor, displaying digital information;
a voice IC, connected to said baseline processor, linking to a microphone and a speaker, wherein voice messages are recorded through said microphone, saved to said voice IC, and played by said speaker;
a memory, connected to said baseline processor, storing the alarm setting entered through said keypad; and
two drivers, connected to said baseline processor, with one connecting to a vibrator, and the other connecting to an electric bell, wherein said drivers activate said vibrator and/or said electric bell according to the preset alarm.

2. The mobile phone with electronic voice date book as claimed in claim 1, wherein the operations of said keypad and said LCD screen can be replaced by a touch-sensitive LCD screen.
